(19) United States
(12) Patent Application Publication
(10) Pub. No.: US 2015/0183986 A1
(43) Pub. Date: Jul. 2, 2015

(54) Flame Retardant Thermoplastic Resin Composition and Molded Article Including the Same

(71) Applicant: Samsung SDI Co., Ltd., Yongin-si (KR)

(72) Inventors: Pil Ho KIM, Uiwang-si (KR); Seung Shik SHIN, Uiwang-si (KR); Kyuong Sik CHIN, Uiwang-si (KR); Ki Hong CHOI, Uiwang-si (KR)

(21) Appl. No.: 14/583,958

(22) Filed: Dec. 29, 2014

(30) Foreign Application Priority Data
Dec. 30, 2013 (KR) 10-2013-0167512

(51) Int. Cl. C08L 69/00

(52) U.S. Cl. CPC C08L 69/00

(57) ABSTRACT

A thermoplastic resin composition includes a polycarbonate resin, a rubber-modified aromatic vinyl copolymer resin, a phosphorus flame retardant, fillers, a flow promoter, and a modified polyolefin resin, wherein the flow promoter includes an alicyclic hydrocarbon resin. The thermoplastic resin composition can exhibit excellent properties in terms of stiffness, impact resistance, fluidity, flame retardancy, and the like, and can be formed as a thin film.

### CROSS-REFERENCE TO RELATED APPLICATION

This application claims priority under 35 USC Section 119 to and the benefit of Korean Patent Application No. 10-2013-0167512, filed Dec. 30, 2013, the entire disclosure of which is incorporated herein by reference.

### FIELD OF THE INVENTION

The present invention relates to a flame retardant thermoplastic resin composition and a molded article including the same.

### BACKGROUND

Polycarbonate resins are engineering plastics which exhibit excellent properties in terms of mechanical strength, heat resistance, transparency, and the like, and thus have been applied to various fields such as office automation, electrical/electronic products, construction materials, and the like. Resins used in electrical/electronic products, in particular, resins used as an exterior of a laptop, and the like, are required to have high flame retardancy and high stiffness. In addition, because of slimming and thinning of TVs, monitors, laptops, and the like, the resins require high fluidity.

On the other hand, rubber-modified aromatic vinyl copolymer resins exhibit excellent properties in terms of processability, impact strength, and appearance, and thus are used in electrical/electronic products, along with polycarbonate resins.

Also, equipment emitting heat has been manufactured using flame retardant resins.

In order to impart flame retardancy to such resin compositions, halogen flame retardants and antimony or phosphorus compounds have been used in the art. However, when the halogen flame retardants are used, gases generated therefrom during burning can have fatal influence on a human body. Thus, there has been a focus on flame retardants that do not include halogen compounds.

For such flame retardation, phosphorus or nitrogen compounds added to impart flame retardancy to resin compositions have been studied. In particular, flame retardation using phosphorus compounds has been widely studied. Among the phosphorus compounds, a phosphoric acid ester flame retardant is representatively used. However, resin compositions using a phosphoric acid ester flame retardant have a problem in that a so-called “juicing” phenomenon occurs, which means that flame retardants migrate and deposit onto a surface of a molded body during molding, and thus, the resin compositions suffer from sharp deterioration in heat resistance. To solve such a problem, a certain amount of fillers may be added to the resin compositions. However, this can deteriorate stiffness.

Therefore, there is a need for a thermoplastic resin composition which exhibits excellent stiffness, impact resistance, fluidity, flame retardancy, and a balance therebetween even when the resin composition includes a phosphorus compound and fillers.

### SUMMARY

Embodiments of the present invention provide a flame retardant thermoplastic resin composition which can exhibit excellent flame retardancy with minimal or no deterioration in stiffness, impact resistance, fluidity, and the like, and is eco-friendly because halogen flame retardants are not required; and a molded article including the same.

The thermoplastic resin composition includes: a polycarbonate resin; a rubber-modified aromatic vinyl copolymer resin; a phosphorus flame retardant; fillers; a flow promoter; and a modified polyolefin resin, wherein the flow promoter includes an alicyclic hydrocarbon resin.

In exemplary embodiments, the thermoplastic resin composition may include about 100 parts by weight of the polycarbonate resin; about 5 parts by weight to about 30 parts by weight of the rubber-modified aromatic vinyl copolymer resin; about 10 parts by weight to about 30 parts by weight of the phosphorus flame retardant; about 5 parts by weight to about 50 parts by weight of the fillers; about 0.1 parts by weight to about 10 parts by weight of the flow promoter; and about 1 part by weight to about 20 parts by weight of the modified polyolefin resin.

In exemplary embodiments, the rubber-modified aromatic vinyl copolymer resin may include about 10 wt % to about 100 wt % of a graft copolymer resin in which an aromatic vinyl monomer and a monomer copolymerizable with the aromatic vinyl monomer are grafted to a rubbery polymer; and about 0 wt % to about 90 wt % of an aromatic vinyl copolymer resin in which an aromatic vinyl monomer is copolymerized with a monomer copolymerizable with the aromatic vinyl monomer.

In exemplary embodiments, the rubber-modified aromatic vinyl copolymer resin may include at least one of acrylonitrile-butadiene-styrene (ABS) copolymer resins, acrylonitrile-ethylene-propylene rubber-styrene (AES) copolymer resins, and acrylonitrile-acrylic rubber-styrene (AAS) copolymer resins.

In exemplary embodiments, the phosphorus flame retardant may include an aromatic phosphoric acid ester compound represent by Formula 2:

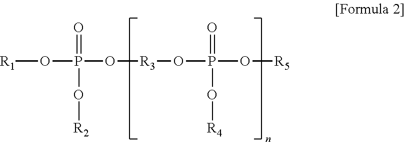

wherein R₁, R₂, R₄ and R₅ are the same or different and are each independently a hydrogen atom, a C₆ to C₂₀ aryl group, or a C₁ to C₁₀ alkyl-substituted C₆ to C₂₀ aryl group, R₃ is a C₆ to C₂₀ arylene group or a C₁ to C₁₀ alkyl-substituted C₆ to C₂₀ arylene group, and n is an integer from 0 to 4.

In exemplary embodiments, the fillers may include at least one of talc, glass fibers, whisker, silica, mica, wollastonite, and basalt fibers.

In exemplary embodiments, the flow promoter may include an alicyclic hydrocarbon resin polymerized from a monomer including a C₅ to C₁₀ cyclic (di)olefin having a number-average molecular weight of about 100 g/mol to about 2,000 g/mol.

In exemplary embodiments, the modified polyolefin resin may include a copolymer of olefin and a compound including at least one of alkyl (meth)acrylates, ethylenically unsaturated group-containing modified esters, ethylenically unsaturated group-containing arylates, maleic anhydrides, and acrylonitrile.

In exemplary embodiments, the thermoplastic resin composition may further include at least one of UV stabilizers, fluorescent whitening agents, release agents, nucleating agents, lubricants, antistatic agents, stabilizers, reinforcing agents, pigments, and dyes.

In exemplary embodiments, the thermoplastic resin composition may have a flame retardancy level of V-0 or higher, as measured on a 1.2 mm thick specimen in accordance with a UL-94 vertical flammability test method; a flexural modulus of about 37,000 kgf/cm² to about 55,000 kgf/cm² as measured in accordance with ASTM D790; an Izod impact strength of about 10 kgf·cm/cm to about 30 kgf·cm/cm as measured on an about ⅛″thick specimen in accordance with ASTM D256; and/or a melt index (MI) of about 30 g/10 min to about 80 g/10 min as measured in accordance with ASTM D1238.

The present invention also relates to a molded article formed from the thermoplastic resin composition.

### DETAILED DESCRIPTION

Exemplary embodiments now will be described more fully hereinafter in the following detailed description, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

A thermoplastic resin composition according to exemplary embodiments of the invention includes: (A) a polycarbonate resin; (B) a rubber-modified aromatic vinyl copolymer resin; (C) a phosphorus flame retardant; (D) fillers; (E) a flow promoter; and (F) a modified polyolefin resin.

(A) Polycarbonate Resin

The polycarbonate resin is a thermoplastic polycarbonate resin, for example, an aromatic polycarbonate resin prepared by reacting a carbonate precursor, such as phosgene, halogen formate, or carbonate diester with one or more diphenols (aromatic dihydroxy compounds) represented by Formula 1:

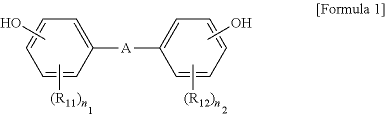

wherein A is a single bond, a substituted or unsubstituted C₁ to C₂₀ alkylene group, a substituted or unsubstituted C₂ to C₅ alkylidene group, a substituted or unsubstituted C₅ to C₆ cycloalkylene group, a substituted or unsubstituted C₅ to C₆ cycloalkylidene group, —CO—, —S—, or —SO₂—; R₁₁ and R₁₂ are the same or different and are each independently a substituted or unsubstituted C₁ to C₃₀ alkyl group or a substituted or unsubstituted C₆ to C₃₀ aryl group; and n₁ and n₂ are the same or different and are each independently an integer from 0 to 4.

As used herein, the term “substituted” means that one or more hydrogen atoms are substituted with a halogen group, a C₁ to C₃₀ alkyl group, a C₁ to C₃₀ haloalkyl group, a C₆ to C₃₀ aryl group, a C₂ to C₃₀ heteroaryl group, a C₁ to C₂₀ alkoxy group, or a mixture thereof. As used herein, the term “hetero” refers to one or more of N, O, S, and/or P atoms in place of a carbon atom.

Examples of the diphenols may include without limitation 4,4′-biphenol, 2,2-bis-(4-hydroxyphenyl)-propane, 2,4-bis-(4-hydroxyphenyl)-2-methylbutane, 1,1-bis-(4-hydroxyphenyl)-cyclohexane, 2,2-bis-(3-chloro-4-hydroxyphenyl)-propane, 2,2-bis-(3,5-dichloro-4-hydroxyphenyl)-propane, and the like, and mixtures thereof. For example, the diphenol may be 2,2-bis-(4-hydroxyphenyl)-propane, 2,2-bis-(3,5-dichloro-4-hydroxyphenyl)-propane, and/or 1,1-bis-(4-hydroxyphenyl)-cyclohexane, for example 2,2-bis-(4-hydroxyphenyl)-propane, which is also referred to as bisphenol A.

The polycarbonate resin may have a weight average molecular weight (Mw) from about 10,000 g/mol to about 200,000 g/mol, for example, from about 15,000 g/mol to about 80,000 g/mol, without being limited thereto.

The polycarbonate resin may include a branched polycarbonate resin, and may also be prepared by adding about 0.05 mol % to about 2 mol % of a polyfunctional compound containing tri- or higher functional groups, for example, tri- or higher-valent phenol groups, based on the total amount of the diphenols used in polymerization. Also, the polycarbonate resin may be used in the form of a homo-polycarbonate resin, a co-polycarbonate resin, or a blend thereof. In addition, the polycarbonate resin may be partially or completely replaced by an aromatic polyester-carbonate resin obtained by polymerization in the presence of an ester precursor, for example, a bifunctional carboxylic acid.

(B) Rubber-Modified Aromatic Vinyl Copolymer Resin

The rubber-modified aromatic vinyl copolymer resin may include (B1) about 10 wt % to about 100 wt % of a graft copolymer resin in which an aromatic vinyl monomer and a monomer copolymerizable with the aromatic vinyl monomer are grafted to a rubbery polymer; and (B2) about 0 wt % to about 90 wt % of an aromatic vinyl copolymer resin in which an aromatic vinyl monomer is copolymerized with a monomer copolymerizable with the aromatic vinyl monomer. In other words, the rubber-modified aromatic vinyl copolymer resin may be prepared using the graft copolymer resin (B1) alone, or may be prepared using a mixture of the graft copolymer resin (B1) and the aromatic vinyl copolymer resin (B2).

In some embodiments, the rubber-modified aromatic vinyl copolymer resin may include (B1) the graft copolymer resin in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 wt %. Further, according to some embodiments of the present invention, the amount of the graft copolymer resin can be in a range from about any of the foregoing amounts to about any other of the foregoing amounts.

In some embodiments, the rubber-modified aromatic vinyl copolymer resin may include (B2) the aromatic vinyl copolymer resin in an amount of 0 (the aromatic vinyl copolymer resin is not present), about 0 (the aromatic vinyl copolymer resin is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the aromatic vinyl copolymer resin can be in a range from about any of the foregoing amounts to about any other of the foregoing amounts.

In exemplary embodiments, the graft copolymer resin (B1) may be polymerized by adding an aromatic vinyl monomer, a monomer copolymerizable with the aromatic vinyl monomer, and the like, to a rubbery polymer, and the aromatic vinyl copolymer resin (B2) may be polymerized by adding an aromatic vinyl monomer, a monomer copolymerizable with the aromatic vinyl monomer, and the like. The above polymerization may be performed by any polymerization method known in the art, such as emulsion polymerization, suspension polymerization, and mass polymerization. Further, in mass polymerization, the rubber-modified aromatic vinyl copolymer resin, in which the graft copolymer resin (B1) is dispersed in a matrix, i.e. the aromatic vinyl copolymer resin (B2), may be prepared through single-step reaction without separately preparing the graft copolymer resin (B1) and the aromatic vinyl copolymer resin (B2).

In one embodiment, a rubber (rubbery polymer) can be present in an amount of about 5 wt % to about 50 wt %, based on the total weight of the final rubber-modified aromatic vinyl copolymer resin. In some embodiments, the final rubber-modified aromatic vinyl copolymer resin may include the rubbery polymer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the rubbery polymer can be in a range from about any of the foregoing amounts to about any other of the foregoing amounts.

Furthermore, the rubber may have a z-average particle size from about 0.05 μm to about 6 μm. Within this range, the thermoplastic resin composition can exhibit excellent properties in terms of impact resistance, and the like.

Hereinafter, the graft copolymer resin (B1) and the aromatic vinyl copolymer resin (B2) will be described in detail.

(B1) Graft Copolymer Resin

The graft copolymer resin may be obtained by grafting an aromatic vinyl monomer and a monomer copolymerizable with the aromatic vinyl monomer to a rubbery polymer, and may further optionally include a monomer for imparting processability and heat resistance, as needed.

Examples of the rubbery polymer may include without limitation diene rubbers such as polybutadiene, poly(styrene-butadiene), poly(acrylonitrile-butadiene), isoprene rubbers, and the like; saturated rubbers obtained by adding hydrogen to the diene rubbers; acrylic rubbers such as poly(butyl acrylate); ethylene-propylene-diene monomer terpolymers (EPDM); and the like, and mixtures thereof. In exemplary embodiments, the rubbery polymer is a diene rubber, for example a butadiene rubber.

The graft copolymer resin (B1) may include the rubbery polymer in an amount of about 5 wt % to about 65 wt %, for example, about 10 wt % to about 60 wt %, and as another example about 20 wt % to about 50 wt %, based on the total weight (100 wt %) of the graft copolymer resin (B1). In some embodiments, the graft copolymer resin (B1) may include the rubbery polymer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or 65 wt %. Further, according to some embodiments of the present invention, the amount of the rubbery polymer can be in a range from about any of the foregoing amounts to about any other of the foregoing amounts. Within this range, the thermoplastic resin composition can have good balance of impact strength and other mechanical properties.

The rubbery polymer (rubbery particles) may have an average (z-average) particle size from about 0.05 μm to about 6 μm, for example, from about 0.15 μm to about 4 μm, and as another example from about 0.25 μm to about 3.5 μm. Within this range, the thermoplastic resin composition can exhibit excellent impact strength and external appearance.

The aromatic vinyl monomer is an aromatic vinyl monomer capable of being grafted to the rubbery copolymer. Examples of the aromatic vinyl monomer may include, without limitation, styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene, and the like, and mixtures thereof. In exemplary embodiments, the aromatic vinyl monomer may be styrene.

The graft copolymer resin (B1) may include the aromatic vinyl monomer in an amount of about 15 wt % to about 94 wt %, for example, about 20 wt % to about 80 wt %, and as another example about 30 wt % to about 60 wt %, based on the total weight (100 wt %) of the graft copolymer resin (B1). In some embodiments, the graft copolymer resin (B1) may include the aromatic vinyl monomer in an amount of about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, or 94 wt %. Further, according to some embodiments of the present invention, the amount of the aromatic vinyl monomer can be in a range from about any of the foregoing amounts to about any other of the foregoing amounts. Within this range, the thermoplastic resin composition can have good balance between impact strength and mechanical properties.

Examples of the monomer copolymerizable with the aromatic vinyl monomer may include without limitation vinyl cyanide compounds, such as acrylonitrile, and the like; and unsaturated nitrile compounds, such as methacrylonitrile, ethacrylonitrile, and the like. These monomers may be used alone or in combination thereof.

The graft copolymer resin (B1) may include the monomer copolymerizable with the aromatic vinyl monomer in an amount of about 1 wt % to about 50 wt %, for example, about 5 wt % to about 45 wt %, and as another example about 10 wt % to about 30 wt %, based on the total weight (100 wt %) of the graft copolymer resin. In some embodiments, the graft copolymer resin (B1) may include the monomer copolymerizable with the aromatic vinyl monomer in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the monomer copolymerizable with the aromatic vinyl monomer can be in a range from about any of the foregoing amounts to about any other of the foregoing amounts. Within this range, the thermoplastic resin composition can have good balance between impact strength and mechanical properties.

Examples of the monomer for imparting processability and heat resistance may include without limitation acrylic acid, methacrylic acid, maleic anhydride, N-substituted maleimide, and the like, and mixtures thereof. The graft copolymer resin (B1) may optionally include the monomer for imparting processability and heat resistance in an amount of about 15 wt % or less, for example, about 0.1 wt % to about 10 wt %, based on the total weight (100 wt %) of the graft copolymer resin. In some embodiments, the graft copolymer resin (B1) may include the monomer for imparting processability and heat resistance in an amount of 0 (the monomer for imparting processability and heat resistance is not present), about 0 (the monomer for imparting processability and heat resistance is present), 0.1, 0.2, 0.3, 0.4, 0.5, 0.6, 0.7, 0.8, 0.9, 1, 2, 3, 4, 5, 6, 7, 8, 9, 10, 11, 12, 13, 14, or 15 wt %. Further, according to some embodiments of the present invention, the amount of the monomer for imparting processability and heat resistance can be in a range from about any of the foregoing amounts to about any other of the foregoing amounts. Within this range, the monomer can impart processability and heat resistance to the thermoplastic resin composition with minimal or no deterioration of other properties.

(B2) Aromatic Vinyl Copolymer Resin

The aromatic vinyl copolymer resin may be prepared using a mixture of the monomers, excluding the rubber (rubbery polymer), used to make the graft copolymer resin (B1), and the ratio of the monomers may vary depending upon compatibility, and the like. For example, the aromatic vinyl copolymer resin may be obtained by copolymerization of the aromatic vinyl monomer and the monomer copolymerizable with the aromatic vinyl monomer.

Examples of the aromatic vinyl monomer may include without limitation styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene, and the like, and mixtures thereof. In exemplary embodiments, the aromatic vinyl monomer may be styrene.

In addition, examples of the monomer copolymerizable with the aromatic vinyl monomer may include without limitation vinyl cyanide compounds, such as acrylonitrile, and the like; and unsaturated nitrile compounds, such as methacrylonitrile, ethacrylonitrile, and the like. These monomers may be used alone or in combination thereof.

The aromatic vinyl copolymer resin may further optionally include the monomer for imparting processability and heat resistance, as needed. Examples of the monomer for imparting processability and heat resistance may include without limitation acrylic acid, methacrylic acid, maleic anhydride, N-substituted maleimide, and the like, and mixtures thereof.

The aromatic vinyl copolymer resin (B2) may include the aromatic vinyl monomer in an amount of about 50 wt % to about 95 wt %, for example, about 60 wt % to about 90 wt %, and as another example about 70 wt % to about 80 wt %, based on the total weight (100 wt %) of the aromatic vinyl copolymer resin. In some embodiments, the aromatic vinyl copolymer resin (B2) may include the aromatic vinyl monomer in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of the aromatic vinyl monomer can be in a range from about any of the foregoing amounts to about any other of the foregoing amounts. Within this range, the thermoplastic resin composition can have a good balance between impact strength and mechanical properties.

The aromatic vinyl copolymer resin (B2) may include monomer copolymerizable with the aromatic vinyl monomer in an amount of about 5 wt % to about 50 wt %, for example, about 10 wt % to about 40 wt %, and as another example about 20 wt % to about 30 wt %, based on the total weight (100 wt %) of the aromatic vinyl copolymer resin. In some embodiments, the aromatic vinyl copolymer resin (B2) may include the monomer copolymerizable with the aromatic vinyl monomer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 11 35, 36, 37, 38, 39, 40, 41, 42, 43, 44, 45, 46, 47, 48, 49, or 50 wt %. Further, according to some embodiments of the present invention, the amount of the monomer copolymerizable with the aromatic vinyl monomer can be in a range from about any of the foregoing amounts to about any other of the foregoing amounts. Within this range, the thermoplastic resin composition can have a good balance between impact strength and mechanical properties.

In addition, the aromatic vinyl copolymer resin (B2) may optionally include the monomer for imparting processability and heat resistance, for example, in an amount of about 30 wt % or less, and as another example, about 0.1 wt % to about 20 wt %, based on the total weight (100 wt %) of the aromatic vinyl copolymer resin. In some embodiments, the aromatic vinyl copolymer resin (B2) may include the monomer for imparting processability and heat resistance in an amount of 0 (the monomer for imparting processability and heat resistance is not present), about 0 (the monomer for imparting processability and heat resistance is present), 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the monomer for imparting processability and heat resistance can be in a range from about any of the foregoing amounts to about any other of the foregoing amounts. Within this range, the monomer can impart processability and heat resistance to the thermoplastic resin composition with minimal or no deterioration of other properties.

The aromatic vinyl copolymer resin may have a weight average molecular weight of about 50,000 g/mol to about 500,000 g/mol, without being limited thereto.

Non-limiting examples of the rubber-modified aromatic vinyl copolymer resin (B) may include a resin obtained from the graft copolymer resin (B1) alone, such as a copolymer (g-ABS) obtained by grafting a styrene monomer, which is an aromatic vinyl compound, and an acrylonitrile monomer, which is an unsaturated nitrile compound, to a core butadiene rubbery polymer; and a resin obtained from a mixture of the graft copolymer resin (B1) and the aromatic vinyl copolymer resin (B2), such as acrylonitrile-butadiene-styrene (ABS) copolymer resins, acrylonitrile-ethylene-propylene rubber-styrene (AES) copolymer resins, and acrylonitrile-acrylic rubber-styrene (AAS) copolymer resins. Here, in the ABS resin, g-ABS, as the graft copolymer resin (B1), is dispersed in a styrene-acrylonitrile (SAN) copolymer resin as the aromatic vinyl copolymer resin (B2).

In the rubber-modified aromatic vinyl copolymer resin (B), the graft copolymer resin (B1) may be present in an amount of about 10 wt % to about 100 wt %, for example, about 15 wt % to about 90 wt %, and the aromatic vinyl copolymer resin (B2) may be optionally present in an amount of about 90 wt % or less, for example, about 10 wt % to about 85 wt %. Within this range, the thermoplastic resin composition can have a good balance between excellent impact strength and mechanical properties.

In exemplary embodiments, the thermoplastic resin composition may include the rubber-modified aromatic vinyl copolymer resin in an amount of about 5 parts by weight to about 30 parts by weight, for example, about 10 parts by weight to about 25 parts by weight, and as another example about 15 parts by weight to about 20 parts by weight, based on about 100 parts by weight of the polycarbonate resin. In some embodiments, the thermoplastic resin composition may include the rubber-modified aromatic vinyl copolymer resin in an amount of about 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the rubber-modified aromatic vinyl copolymer resin can be in a range from about any of the foregoing amounts to about any other of the foregoing amounts. Within this range, the thermoplastic resin composition can exhibit excellent impact resistance, flame retardancy, and the like.

(C) Phosphorus Flame Retardant

The phosphorus flame retardant may include a typical phosphorus flame retardant used in flame retardant thermoplastic resin compositions. Examples of the phosphorus flame retardant may include without limitation red phosphorus, phosphates, phosphonates, phosphinates, phosphine oxides, phosphazenes, metallic salts thereof, and the like. The phosphorus flame retardants may be used alone or in combination thereof.

In exemplary embodiments, the phosphorus retardant includes an aromatic phosphoric ester compound represented by Formula 2:

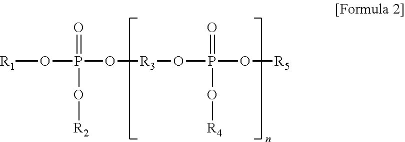

wherein R₁, R₂, R₄ and R₅ are the same or different and are each independently a hydrogen atom, a C₆ to C₂₀ aryl group, or a C₁-C₁₀ alkyl-substituted C₆ to C₂₀ aryl group; R₃ is a C₆ to C₂₀ arylene group or a C₁-C₁₀ alkyl-substituted C₆ to C₂₀ arylene group, for example, derivatives of dialcohol, such as resorcinol, hydroquinone, bisphenol-A, or bisphenol-S; and n is an integer from 0 to 4.

When n is 0 in Formula 2, non-limiting examples of the aromatic phosphoric ester compound represented by Formula 2 may include without limitation diaryl phosphates, such as diphenyl phosphate, triphenyl phosphate, tricresyl phosphate, trixylenyl phosphate, tri(2,6-dimethylphenyl)phosphate, tri(2,4,6-trimethylphenyl)phosphate, tri(2,4-di-tert-butylphenyl)phosphate, tri(2,6-dimethylphenyl)phosphate, and the like. In addition, when n is 1 in Formula 2, examples of the compound represented by Formula 2 may include without limitation bisphenol-A bis(diphenyl phosphate), resorcinol bis(diphenyl phosphate), resorcinol bis[bis(2,6-dimethylphenyl)phosphate], resorcinol bis[bis(2,4-di-tert-butylphenyl)phosphate], hydroquinone bis[bis(2,6-dimethylphenyl)phosphate], hydroquinone bis[bis(2,4-di-tert-butylphenyl)phosphate], and the like. These compounds may be used alone or in combination thereof.

The thermoplastic resin composition may include the aromatic phosphoric ester compound in an amount of about 10 parts by weight to about 30 parts by weight, for example, about 15 parts by weight to about 25 parts by weight, based on about 100 parts by weight of the polycarbonate resin. In some embodiments, the thermoplastic resin composition may include the phosphorus flame retardant in an amount of about 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the phosphorus flame retardant can be in a range from about any of the foregoing amounts to about any other of the foregoing amounts. Within this range, the resin composition can exhibit improved flame retardancy with minimal or no deterioration of other properties.

(D) Filler

The fillers can improve properties of the thermoplastic resin composition, such as stiffness, heat resistance, and the like. The fillers may include any typical organic and/or inorganic fillers. Examples of the inorganic fillers may include without limitation talc, glass fibers, whisker, silica, mica, wollastonite, basalt fibers, and the like, and mixtures thereof, for example, talc and/or glass fibers.

In one embodiment, the inorganic fillers may have an average particle diameter, for example, from about 50 nm to about 100 μm, without being limited thereto.

In exemplary embodiments, as the talc, plate type talc may be used. In addition, the glass fibers may refer to a glass fiber reinforcing agent in which glass filaments coated with a sizing agent such as an epoxy, urethane, silane and the like form fibers. The glass filaments may have an average particle size of about 5 μm to about 20 μm. The glass fiber reinforcing agent may have an average particle size of about 10 μm to about 13 μm, without being limited thereto. Further, the sizing agent may be present in an amount of about 0.05 parts by weight to about 0.1 parts by weight, based on 100 parts by weight of the glass filament.

The thermoplastic resin composition may include fillers in an amount of about 5 parts by weight to about 50 parts by weight, for example, about 10 parts by weight to about 40 parts by weight, based on about 100 parts by weight of the polycarbonate resin. In some embodiments, the thermoplastic resin composition may include the fillers in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 parts by weight. Further, according to some embodiments of the present invention, the amount of the fillers can be in a range from about any of the foregoing amounts to about any other of the foregoing amounts. Within this range, the thermoplastic resin composition can have excellent stiffness, impact resistance, heat resistance, and the like.

(E) Flow Promoter

The flow promoter not only serves to promote a flow, but also can act as a compatibilizer between the resin and the additives (flame retardant, filler, etc.). The flow promoter includes an alicyclic hydrocarbon resin. For example, the flow promoter may be an alicyclic hydrocarbon resin polymerized from a monomer including a C₅ to C₁₀ cyclic (di)olefin. Non-limiting examples of the cyclic (di)olefin may include cyclopentene, cyclopentadiene, cyclohexene, cyclohexadiene, methylcyclopentadiene, dicyclopentadiene, and the like, and mixtures thereof.

The term “(di)olefin” as used herein may refer to both “olefin” and “diolefin”.

The alicyclic hydrocarbon resin may have a number-average molecular weight of about 100 g/mol to about 2,000 g/mol, for example, about 500 g/mol to about 1,500 g/mol. Within this range, it is possible to improve fluidity while maintaining stiffness.

In one embodiment, the alicyclic hydrocarbon resin may be partially or completely hydrogenated and may include any compatibilized alicyclic hydrocarbon resin known in the art. For example, the alicyclic hydrocarbon resin may include an alicyclic hydrocarbon resin, which is polymerized from a C₉ cyclic (di)olefin and completely hydrogenated.

The thermoplastic resin composition may include the flow promoter in an amount of about 0.1 parts by weight to about 10 parts by weight, for example, about 1 part by weight to about 7 parts by weight, and as another example about 1.5 parts by weight to about 5 parts by weight, based on about 100 parts by weight of the polycarbonate resin. In some embodiments, the thermoplastic resin composition may include the flow promoter in an amount of about 0.1, 0.2, 0.3, 0.4, 0.5, 0.6, 0.7, 0.8, 0.9, 1, 2, 3, 4, 5, 6, 7, 8, 9, or 10 parts by weight. Further, according to some embodiments of the present invention, the amount of the flow promoter can be in a range from about any of the foregoing amounts to about any other of the foregoing amounts. Within this range, a thermoplastic resin composition having excellent fluidity can be obtained with minimal or no deterioration in properties, such as flame retardancy, and the like.

(F) Modified Polyolefin Resin

The modified polyolefin resin can serve as an impact modifier. The modified polyolefin resin may be a copolymer of olefin and a compound including at least one of alkyl (meth)acrylates, ethylenically unsaturated group-containing modified esters, ethylenically unsaturated group-containing arylates, maleic anhydride, and/or acrylonitrile.

In one embodiment, examples of the compound copolymerizable with olefin may include without limitation alkyl (meth)acrylates, such as methylacrylate, ethylacrylate, butylacrylate, and the like; ethylenically unsaturated group-containing modified esters, such as glycidyl methacrylate; acrylonitrile; and mixtures thereof. The modified polyolefin resin may include the compound copolymerizable with olefin in an amount of about 5 wt % to about 50 wt %, for example about 5 wt % to about 40 wt %, and as another example about 7 wt % to about 30 wt %, based on about 100 wt % of the modified polyolefin resin. In some embodiments, the modified polyolefin resin may include the compound copolymerizable with olefin in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the compound copolymerizable with olefin can be in a range from about any of the foregoing amounts to about any other of the foregoing amounts. Within this range, the modified polyolefin resin can improve impact resistance of the thermoplastic resin composition with minimal or no deterioration in compatibility.

In one embodiment, the modified polyolefin resin may include about 70 wt % or more of polyethylene, polypropylene, and/or an ethylene-propylene copolymer in a main chain thereof, without being limited thereto.

The modified polyolefin resin may have a melt index (MI) from about 0.01 g/10 min to about 40 g/10 min, for example, from about 0.1 g/10 min to about 10 g/10 min, as measured under conditions of about 190° C. and about 2.16 kgf, without being limited thereto.

The thermoplastic resin composition may include the modified polyolefin resin in an amount of about 1 part by weight to about 20 parts by weight, for example about 1 part by weight to about 15 parts by weight, and as another example about 1.5 parts by weight to about 10 parts by weight, based on about 100 parts by weight of the polycarbonate resin.

In some embodiments, the thermoplastic resin composition may include the modified polyolefin resin in an amount of about 1, 2, 3, 4, 5, 6, 7, 8, 9, 10, 11, 12, 13, 14, 15, 16, 17, 18, 19, or 20 parts by weight. Further, according to some embodiments of the present invention, the amount of the modified polyolefin resin can be in a range from about any of the foregoing amounts to about any other of the foregoing amounts. Within this range, a thermoplastic resin composition having excellent impact resistance and the like can be obtained with minimal or no deterioration in properties, such as flame retardancy, and the like.

The thermoplastic resin composition according to the present invention may further include typical additives, as needed. Examples of the additives may include without limitation UV stabilizers, fluorescent whitening agents, release agents, nucleating agents, lubricants, antistatic agents, stabilizers, reinforcing agents, pigments, dyes, and the like, and mixtures thereof.

In exemplary embodiments, the UV stabilizer serves to suppress discoloration and deterioration in light reflectance of the resin composition due to UV irradiation, and may include compounds such as benzotriazole, benzophenone, triazine, and the like and mixtures thereof.

The fluorescent whitening agent serves to improve light reflectivity of the polycarbonate resin composition, and may include stilbene-bisbenzooxazole derivatives, such as 4-(benzooxazole-2-yl)-4′-(5-methylbenzooxazole-2-yl)stilbene, 4,4′-bis(benzooxazole-2-yl)stilbene, and the like, and mixtures thereof.

Examples of the release agent may include without limitation fluorine-containing polymers, silicone oils, metallic salts of stearyl acid, metallic salts of montanic acid, montanic acid ester waxes, polyethylene waxes, and the like, and mixtures thereof.

Examples of the nucleating agent may include without limitation clay, without being limited thereto.

In use, the additives may be present in an amount of about 0.01 parts by weight to about 10 parts by weight based on about 100 parts weight of the thermoplastic resin, without being limited thereto.

In exemplary embodiments, the thermoplastic resin composition may have a flame retardancy level of V-0 or higher, as measured on a 1.2 mm thick specimen in accordance with a UL94 vertical flammability test method.

The thermoplastic resin composition may have a flexural modulus from about 37,000 kgf/cm² to about 55,000 kgf/cm², for example, from about 38,000 kgf/cm² to about 45,000 kgf/cm², as measured in accordance with ASTM D790.

The thermoplastic resin composition may have an Izod impact strength from about 10 kgf·cm/cm to about 30 kgf·cm/cm, for example, from about 14 kgf·cm/cm to about 25 kgf·cm/cm, as measured on an about ⅛″thick specimen in accordance with ASTM D256.

In addition, the thermoplastic resin composition may have a melt index (MI) from about 30 g/10 min to about 80 g/10 min, for example, from about 33 g/10 min to about 50 g/10 min, as measured in accordance with ASTM D1238.

Exemplary embodiments also include a molded article is formed from the above thermoplastic resin composition. The thermoplastic resin composition according to the present invention may be prepared by a method of preparing a thermoplastic resin composition known in the art. For example, the above components and, optionally, one or more additives can be mixed, followed by melt extrusion in an extruder, to prepare a resin composition in the form of pellets. The prepared pellets may be produced into various molded articles (products) through various molding methods, such as injection molding, extrusion, vacuum molding, casting, and the like. Such molding methods are well known to those skilled in the art. Since the molded article can exhibit excellent properties in terms of stiffness, impact resistance, fluidity, flame retardancy, and the like, and can be formed as a thin film, the molded article is useful for components of electric/electronic products, such as a laptop housing, automotive components, exterior materials and the like, which require these properties.

Hereinafter, the present invention will be described in more detail with reference to the following examples. It should be understood that these examples are provided for illustration only and are not to be construed in any way as limiting the present invention.

### EXAMPLES

Details of components used in the following Examples and Comparative Examples are as follows:

(A) Polycarbonate Resin

Bisphenol A-type polycarbonate having a weight average molecular weight (Mw) of 25,000 g/mol is used.

(B) Rubber-Modified Aromatic Vinyl Copolymer Resin

A resin prepared by kneading 40 wt % of (B-1) a styrene graft copolymer resin and 60 wt % of (B-2) a styrene-containing copolymer resin is used.

(B-1) Styrene Graft Copolymer Resin (ABS Graft Copolymer Resin)

In a reactor, 50 parts by weight of butadiene rubber latex in terms of solid content is placed, followed by adding 36 parts by weight of styrene, 14 parts by weight of acrylonitrile, and 150 parts by weight of deionized water. Then, based on total solid content, 1.0 part by weight of potassium oleate, 0.4 parts by weight of cumene hydroperoxide, 0.2 parts by weight of a mercaptan chain transfer agent, 0.4 parts by weight of glucose, 0.01 parts by weight of iron sulfate hydrate, and 0.3 parts by weight of pyrophosphate sodium salt are placed in the reactor, followed by reaction at 75° C. for 5 hours, thereby preparing a graft copolymer resin latex. 0.4 parts by weight of sulfuric acid based on solid content of the resin latex is introduced into the resin latex to coagulate the resin latex, thereby preparing a styrene graft copolymer resin in powder form.

(B-2) Styrene-Containing Copolymer Resin (SAN Copolymer Resin)

In a reactor, 72 parts by weight of styrene, 28 parts by weight of acrylonitrile, 120 parts by weight of deionized water, 0.2 parts by weight of azobisisobutyronitrile, 0.4 parts by weight of tricalcium phosphate, and 0.2 parts by weight of a mercaptan chain transfer agent are placed, followed by heating the reactor to 80° C. for 90 minutes at room temperature, and then maintaining the reactor at 80° C. for 240 minutes, thereby preparing a styrene-acrylonitrile copolymer resin (SAN) with acrylonitrile content of 25 wt %. The prepared copolymer resin is subjected to washing, dehydration, and drying, thereby preparing a styrene-containing copolymer resin in powder form. The prepared styrene-containing copolymer resin has a weight average molecular weight of 180,000 g/mol to 200,000 g/mol.

(C) Phosphorus Flame Retardant

An aromatic phosphoric acid ester compound (diarylphosphate, PX-200, DAIHACHI Chemical Industry Co., Ltd.) is used.

(D) Filler

Plate type talc (UPN HS-T 0.5, HAYASHI Chemical) is used.

(E) Flow Promoter

(E1) Alicyclic hydrocarbon resin (ARKRON P-125, ARAKAWA) is used.

(E2) Amorphous polyester resin (BR-8040, SKC) is used.

(F) Modified Polyolefin Resin

A modified polyolefin resin (ELVAFLEX A714, DuPont) having a polyethylene main chain and copolymerized with ethylacrylate is used.

### Examples 1 to 4 and Comparative Examples 1 to 5

According to compositions and amounts as listed in Table 1, the components are introduced into a 32 L/D twin-screw type extruder having a diameter of 45 mm, followed by melting and extrusion at 240° C. to 280° C., thereby preparing pellets. The prepared pellets are dried at 80° C. for 5 hours or more, followed by injection molding using a 3 oz screw type injection machine at 240° C. to 280° C., thereby preparing a specimen. The prepared specimen is evaluated as to the following properties, and results are shown in Table 1.

Property Evaluation

(1) Flame retardancy level: Flame retardancy level is measured on 1.2 mm thick specimens according to the UL-94 vertical flammability test method.

(2) Vicat softening temperature (VST, unit: ° C.): Vicat softening temperature is measured at a load of 5 kgf in accordance with ASTM D1525.

(3) Izod impact strength (unit: kgf·cm/cm): Izod impact strength is measured on ⅛″thick notched Izod specimens in accordance with ASTM D256.

(4) Flexural modulus (unit: kgf/cm²): Flexural modulus is measured on 6.4 mm thick specimens in accordance with ASTM D790.

(5) Melt index (MI, unit: g/10 min): Melt index is measured under conditions of 300° C. and 10 kgf in accordance with ASTM D1238.

TABLE 1

| | | Example | | | | Comparative Example | | | | |
|---|---|---|---|---|---|---|---|---|---|---|
| | | 1 | 2 | 3 | 4 | 1 | 2 | 3 | 4 | 5 |
| (A) (parts by weight) | | 100 | 100 | 100 | 100 | 100 | 100 | 100 | 100 | 100 |
| (B) (parts by weight) | | 15 | 15 | 15 | 20 | — | 15 | 15 | 15 | 15 |
| (C) (parts by weight) | | 20 | 20 | 20 | 20 | 20 | 20 | 20 | 20 | 20 |
| (D) (parts by weight) | | 20 | 20 | 20 | 20 | 20 | 20 | 20 | — | 20 |
| (E) (parts by | (E1) | 5 | 5 | 7 | 5 | 5 | 5 | — | 5 | — |
| weight) | (E2) | — | — | — | — | — | — | — | — | 5 |

| | | | | | | | | | |
|---|---|---|---|---|---|---|---|---|---|
| (F) (parts by weight) | 5 | 12 | 5 | 5 | 5 | — | 5 | 5 | 5 |
| Flame retardancy level | V-0 | V-0 | V-0 | V-0 | V-0 | Fail | V-0 | V-1 | Fail |
| VST | 95 | 91 | 93 | 94 | 105 | 94 | 97 | 95 | 87 |
| Izod impact strength | 14 | 18 | 15 | 14 | 3 | 3 | 9 | 12 | 4 |
| Flexural modulus | 41000 | 38000 | 38000 | 40000 | 44500 | 42500 | 38000 | 24000 | 42000 |
| Melt index | 34 | 37 | 36 | 33 | 35 | 34 | 26 | 30 | 36 |

From Table 1, it can be seen that the thermoplastic resin composition according to the invention (Examples 1 to 4) exhibits excellent impact strength, fluidity, and flame retardancy without deterioration in stiffness (flexural modulus).

Conversely, it can be seen that the thermoplastic resin composition of Comparative Example 1, which did not include the rubber-reinforced vinyl copolymer resin (B1), suffers from significant deterioration in impact strength, and the thermoplastic resin composition of Comparative Example 2, which did not include the modified polyolefin resin (F), suffers from significant deterioration in flame retardancy and impact strength. In addition, it can be seen that the thermoplastic resin composition of Comparative Example 3, which did not include the flow promoter (E), suffers from significant deterioration in fluidity, impact resistance, stiffness, and the like, and the thermoplastic resin composition of Comparative Example 4, which did not include the fillers (D), suffers from significant deterioration in flame retardancy, stiffness, and the like. Furthermore, it can be seen that the thermoplastic resin composition of Comparative Example 5, in which the alicyclic hydrocarbon resin is not used as the flow promoter, suffers from significant deterioration in flame retardancy.

Many modifications and other embodiments of the invention will come to mind to one skilled in the art to which this invention pertains. Therefore, it is to be understood that the invention is not to be limited to the specific embodiments disclosed and that such modifications and other embodiments are intended to be included within the scope of the appended claims.

What is claimed is:

1. A thermoplastic resin composition comprising:
a polycarbonate resin;
a rubber-modified aromatic vinyl copolymer resin;
a phosphorus flame retardant;
fillers;
a flow promoter; and
a modified polyolefin resin,
wherein the flow promoter comprises an alicyclic hydrocarbon resin.

2. The thermoplastic resin composition according to claim 1, comprising: about 100 parts by weight of the polycarbonate resin; about 5 parts by weight to about 30 parts by weight of the rubber-modified aromatic vinyl copolymer resin; about 10 parts by weight to about 30 parts by weight of the phosphorus flame retardant; about 5 parts by weight to about 50 parts by weight of the fillers; about 0.1 parts by weight to about 10 parts by weight of the flow promoter; and about 1 part by weight to about 20 parts by weight of the modified polyolefin resin.

3. The thermoplastic resin composition according to claim 1, wherein the rubber-modified aromatic vinyl copolymer resin comprises: about 10 wt % to about 100 wt % of a graft copolymer resin in which an aromatic vinyl monomer and a monomer copolymerizable with the aromatic vinyl monomer are grafted to a rubbery polymer; and about 0 wt % to about 90 wt % of an aromatic vinyl copolymer resin in which an aromatic vinyl monomer is copolymerized with a monomer copolymerizable with the aromatic vinyl monomer.

4. The thermoplastic resin composition according to claim 1, wherein the rubber-modified aromatic vinyl copolymer resin comprises acrylonitrile-butadiene-styrene (ABS) copolymer resin, acrylonitrile-ethylene-propylene rubber-styrene (AES) copolymer resin, acrylonitrile-acrylic rubber-styrene (AAS) copolymer resin, or a mixture thereof.

5. The thermoplastic resin composition according to claim 1, wherein the phosphorus flame retardant comprises an aromatic phosphoric acid ester compound represent by Formula 2: 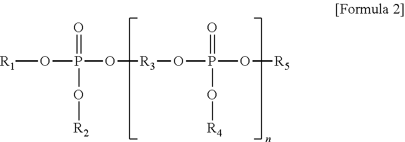
wherein R₁, R₂, R₄ and R₅ are the same or different and are each independently a hydrogen atom, a C₆ to C₂₀ aryl group, or a C₁ to C₁₀ alkyl-substituted C₆ to C₂₀ aryl group, R₃ is a C₆ to C₂₀ arylene group or a C₁ to C₁₀ alkyl-substituted C₆ to C₂₀ arylene group, and n is an integer from 0 to 4.

6. The thermoplastic resin composition according to claim 1, wherein the fillers comprise talc, glass fibers, whisker, silica, mica, wollastonite, basalt fibers, or a mixture thereof.

7. The thermoplastic resin composition according to claim 1, wherein the flow promoter comprises an alicyclic hydrocarbon resin polymerized from a monomer comprising a C₅ to C₁₀ cyclic (di)olefin and having a number-average molecular weight of about 100 g/mol to about 2,000 g/mol.

8. The thermoplastic resin composition according to claim 1, wherein the modified polyolefin resin comprises a copolymer of olefin and a compound comprising an alkyl (meth)acrylate, ethylenically unsaturated group-containing modified ester, ethylenically unsaturated group-containing arylate, maleic anhydride, acrylonitrile, or a mixture thereof.

9. The thermoplastic resin composition according to claim 1, further comprising a UV stabilizer, fluorescent whitening agent, release agent, nucleating agent, lubricant, antistatic agent, stabilizer, reinforcing agent, pigment, dye, or a mixture thereof.

10. The thermoplastic resin composition according to claim 1, wherein the thermoplastic resin composition has a flame retardancy level of V-0 or higher as measured on a 1.2 mm thick specimen in accordance with a UL94 vertical flammability test method; a flexural modulus of about 37,000 kgf/cm² to about 55,000 kgf/cm² as measured in accordance with ASTM D790; an Izod impact strength of about 10 kgf·cm/cm to about 30 kgf·cm/cm as measured on an about ⅛″thick specimen in accordance with ASTM D256; and a melt index (MI) of about 30 g/10 min to about 80 g/10 min as measured in accordance with ASTM D1238.

11. A molded article formed from the thermoplastic resin composition according to claim 1.
